(19) United States
(12) Patent Application Publication
(10) Pub. No.: US 2005/0052356 A1
(43) Pub. Date: Mar. 10, 2005

(54) Plasma display panel driving method and plasma display device

(76) Inventors: Woo-Joon Chung, Suwon-si (KR); Jin-Sung Kim, Suwon-si (KR); Seung-Hun Chae, Suwon-si (KR); Kyoung-Ho Kang, Suwon-si (KR)

Correspondence Address: CHRISTIE, PARKER & HALE, LLP, PO BOX 7068, PASADENA, CA, 91109-7068, US

(21) Appl. No.: 10/911,383

(22) Filed: Aug. 4, 2004

(30) Foreign Application Priority Data
Aug. 5, 2003 (KR) 10-2003-0054051

(51) Int. Cl. G09G 3/28

(52) U.S. Cl. 345/60

(57) ABSTRACT

A PDP driving method. No rising ramp voltage is applied to a scan electrode during a reset period. The final voltage of a falling ramp voltage is reduced to a voltage by which all the discharge cells can fire the discharge during the reset period. A difference between the voltage applied to the address electrode of the discharge cell to be selected and the voltage applied to the scan electrode is established to be greater than the maximum discharge firing voltage.

### CROSS REFERENCE TO RELATED APPLICATION

This application claims priority to and the benefit of Korea Patent Application No. 2003-54051 filed on Aug. 5, 2003 in the Korean Intellectual Property Office, the content of which is incorporated herein by reference.

### BACKGROUND OF THE INVENTION

(a) Field of the Invention

The present invention relates to a plasma display panel (PDP) driving method and a plasma display device.

(b) Description of the Related Art

A PDP is a flat display panel for showing characters or images using plasma generated by gas discharge. PDPs can include pixels numbering more than several million in a matrix format, in which the number of pixels are determined by the size of the PDP. Referring to FIGS. 1 and 2, a PDP structure will now be described.

FIG. 1 shows a partial perspective view of the PDP and FIG. 2 schematically shows an electrode arrangement of the PDP. As shown in FIG. 1, the PDP includes glass substrates 1, 6 facing each other with a predetermined gap therebetween. Scan electrodes 4 and sustain electrodes 5 in pairs are formed in parallel on glass substrate 1. Scan electrodes 4 and sustain electrodes 5 are covered with dielectric layer 2 and protection film 3. A plurality of address electrodes 8 is formed on glass substrate 6. Address electrodes 8 are covered with insulator layer 7. Barrier ribs 9 are formed on insulator layer 7 between address electrodes 8. Phosphors 10 are formed on the surface of insulator layer 7 and between barrier ribs 9. Glass substrates 1, 6 are provided facing each other with discharge spaces between glass substrates 1, 6 so that scan electrodes 4 and sustain electrodes 5 can cross address electrodes 8. Discharge space 11 between address electrode 8 and a crossing part of a pair of scan electrode 4 and sustain electrode 5 forms discharge cell 12, one of which is schematically indicated.

As shown in FIG. 2, the electrodes of the PDP have an n x m matrix format. Address electrodes A₁ to Aₘ are arranged in the column direction, and n scan electrodes Y₁ to Yₙ and n sustain electrodes X₁ to Xₙ are arranged in the row direction. Scan/sustain driving circuit 20 is coupled to scan electrodes Y₁ to Yₙ and sustain electrodes X₁ to Xₙ, and address driving circuit 30 is coupled to address electrodes A₁ to Aₘ.

U.S. Pat. No. 6,294,875 by Kurata for driving a PDP discloses a method for dividing one field into eight subfields and applying different waveforms in the reset period of the first subfield and the second to eighth subfields.

As shown in FIG. 3, a subfield includes a reset period, an address period, and a sustain period. A ramp waveform which gradually rises from voltage Vₚ of less than a discharge firing voltage to voltage Vᵣ that is greater than the discharge firing voltage is applied to scan electrodes Y₁ to Yₙ during the reset period of the first subfield. Weak discharges are generated to address electrodes A₁ to Aₘ and sustain electrodes X₁ to Xₘ from scan electrodes Y₁ to Yₙ while the ramp waveform rises. Negative wall charges are accumulated to scan electrodes Y₁ to Yₙ, and positive wall charges are accumulated to address electrodes A1 to Am and sustain electrodes X₁ to Xₘ because of the discharges. The wall charges are actually formed on protection film 3 on scan electrodes 4 and sustain electrodes 5 in FIG. 1, but the wall charges are described as being generated on scan electrodes 4 and sustain electrodes 5 below for ease of description.

A ramp voltage which gradually falls from voltage V_{q} of less than the discharge firing voltage to voltage 0V (volts) is applied to scan electrodes Y₁ to Yₙ. A weak discharge is generated on scan electrodes Y₁ to Yₙ from sustain electrodes X₁ to Xₘ and address electrodes A₁ to Aₘ by a wall voltage formed at the discharge cells while the ramp voltage falls. Part of the wall charges formed on sustain electrodes X₁ to Xₘ, scan electrodes Y₁ to Yₙ, and address electrodes A₁ to Aₘ are erased by the discharge, and they are established to be appropriate for addressing. In a like manner, the wall charges are actually formed on the surface of insulator layer 7 of address electrode 8 in FIG. 1, but they are described as being formed on address electrode 8 for ease of description.

Next, when positive voltage V_{w} is applied to address electrodes A₁ to Aₘ of the discharge cells to be selected, and 0V is applied to scan electrodes Y₁ to Yₙ in the address period, address discharging is generated between address electrodes A₁ to Aₘ and scan electrodes Y₁ to Yₙ and between sustain electrodes X₁ to Xₘ and scan electrodes Y₁ to Yₙ by the wall voltage caused by the wall charges formed during the reset period and positive voltage V_{w}. By the address discharging, positive wall charges are accumulated on scan electrodes Y₁ to Yₙ, and negative wall charges are accumulated on sustain electrodes X₁ to Xₘ and address electrodes A₁ to Aₘ. Sustain discharging is generated on the discharge cells on which the wall charges are accumulated by the address discharging, by a sustain pulse applied during the sustain period.

A voltage level of the last sustain pulse applied to scan electrodes Y₁ to Yₙ during the sustain period of the first subfield corresponds to voltage Vᵣ of the reset period, and voltage (Vᵣ-Vₛ) corresponding to a difference between voltage Vᵣ and sustain voltage Vₛ is applied to sustain electrodes X₁ to Xₘ. A discharge is generated from scan electrodes Y₁ to Yₙ to address electrodes A₁ to Aₘ because of the wall voltage formed by the address discharging, and sustain discharging is generated from scan electrodes Y₁ to Yₙ to sustain electrodes X₁ to Xₘ in the discharge cells selected in the address period. The discharges correspond to the discharges generated by the rising ramp voltage in the reset period of the first subfield. No discharge occurs in the discharge cells which are not selected since no address discharging is provided in the discharge cells.

In the reset period of the second following subfield, voltage Vₕ is applied to sustain electrodes X₁ to Xₘ, and a ramp voltage which gradually falls from voltage V_{q} to 0V is applied to scan electrodes Y₁ to Yₙ. That is, the voltage which corresponds to the falling ramp voltage applied during the reset period of the first subfield is applied to scan electrodes Y₁ to Yₙ. A weak discharge is generated on the discharge cells selected in the first subfield, and no discharge is generated on the discharge cells that are not selected. In the reset period of the last following subfield, the same waveform as that of the reset period of the second subfield is applied. An erase period is formed after the sustain period in the eighth subfield. A ramp voltage which gradually rises from 0V to voltage Vₑ is applied to sustain electrodes X₁ to Xₘ during the erase period. The wall charges formed in the discharge cells are erased by the ramp voltage.

As to the above-described conventional driving waveforms, discharges are generated on all the discharge cells by the rising ramp voltage in the reset period of the first subfield, and accordingly, the discharges problematically occur in the cells which are not to be displayed, thereby worsening the contrast ratio. Further, since the addressing is sequentially performed on all the scan electrodes in the address period of using an internal wall voltage, the internal wall voltage of the scan electrodes that are selected in the later stage is lost. The lost wall voltage reduces margins as a result.

### SUMMARY OF THE INVENTION

In accordance with the present invention a PDP driving method is provided for performing addressing without using an internal wall voltage.

In accordance with the present invention, the wall voltage is rarely used for the addressing.

In one aspect of the present invention, a method for driving a PDP having a plurality of first and second electrodes formed in parallel on a first substrate, and a plurality of address electrodes which cross the first and second electrodes and are formed on a second substrate, wherein the adjacent first electrode, the second electrode, and the address electrode form a discharge cell, includes: gradually reducing a voltage generated by subtracting a voltage at the address electrode from a voltage at the first electrode to a second voltage from a first voltage, during a reset period; respectively applying a third voltage and a fourth voltage to the first electrode and the address electrode of the discharge cell to be selected from among the discharge cells, during an address period; and sustain discharging the discharge cell selected in the address period, during a sustain period, wherein the second voltage is substantially less than a negative value of half of the voltage applied to the first and second electrodes for the sustain discharging in the sustain period.

The second voltage substantially is less than a negative value of 80% of a voltage difference between the first and second electrodes for the sustain discharging in the sustain period.

The second voltage is substantially greater than a discharge firing voltage between the first electrode and the address electrode. The discharge firing voltage fires a discharge when substantially no wall charges are formed in the discharge cell. A wall voltage between the first electrode and the address electrode is substantially eliminated during the reset period. The discharge firing voltage is the greatest one from among the discharge firing voltages of the discharge cell in a valid display region.

A difference of the third and fourth voltages is greater than the discharge firing voltage.

In another aspect of the present invention, a plasma display includes: a first substrate; a plurality of first electrodes and second electrodes formed in parallel on the first substrate; a second substrate facing the first substrate with a gap therebetween; a plurality of third electrodes crossing the first and second electrodes and being formed on the second substrate; and a driving circuit for supplying a driving voltage to the first, second, and third electrodes so as to discharge the discharge cells formed by the adjacent first, second, and third electrodes. The driving circuit gradually reduces a voltage generated by subtracting a voltage at the third electrode from a voltage at the first electrode to a first voltage during a reset period, discharges a discharge cell to be selected from among the discharge cells during an address period, and sustain-discharges the selected discharge cell during a sustain period. The first voltage is substantially less than a negative value of half of the voltage applied to the first and second electrodes for the sustain discharging in the sustain period.

In still another aspect of the present invention, a method is provided for driving a PDP which has a plurality of first and second electrodes formed in parallel on a first substrate, and a plurality of third electrodes which cross the first and second electrodes and are formed on a second substrate. The adjacent first electrode, the second electrode, and the third electrode form a discharge cell. A field is divided into a plurality of subfields and then driven, each subfield includes a reset period, an address period, and a sustain period. All subfields respectively form at least one field. The method includes: gradually reducing a voltage at the first electrode to a second voltage from a first voltage during the reset period; respectively applying a third voltage and a fourth voltage to the first electrode and the third electrode of the discharge cell to be selected from among the discharge cells, during the address period; and sustain discharging the discharge cell selected in the address period, during the sustain period, wherein the voltage at the first electrode falls to the first voltage after the last pulse of the sustain period of the previous subfield.

In still yet another aspect of the present invention, a method is provided for driving a PDP which has a plurality of first and second electrodes formed in parallel on a first substrate, and a plurality of address electrodes which cross the first and second electrodes and are formed on a second substrate. An adjacent first electrode, second electrode, and address electrode form a discharge cell. The method includes: sequentially applying a first voltage to the first electrodes, and applying a second voltage to the address electrode while the first voltage is applied to the first electrode of the discharge cell to be selected from among the discharge cells, wherein the first voltage is substantially less than a negative value of half of the difference of voltages applied to the first and second electrodes for sustain discharge in the sustain period.

### BRIEF DESCRIPTION OF THE DRAWINGS

FIG. 1 shows a brief perspective view of a general PDP.

FIG. 2 shows an electrode arrangement diagram of a general PDP.

FIG. 3 shows a conventional PDP driving waveform diagram.

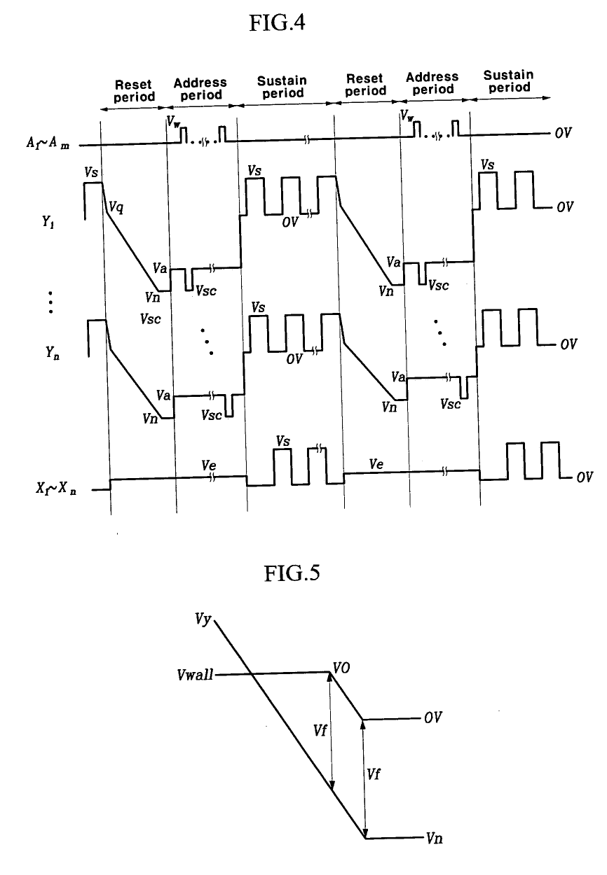

FIGS. 4, 6, and 7 show PDP driving waveform diagrams according to first to third exemplary embodiments of the present invention.

FIG. 5 shows a relational diagram between a falling ramp voltage and a wall voltage when the falling ramp voltage is applied to the discharge cells.

FIG. 8A shows a voltage applied diagram for measuring the discharge firing voltage, and FIG. 8B shows discharged states in the sustain period and the reset period.

### DETAILED DESCRIPTION

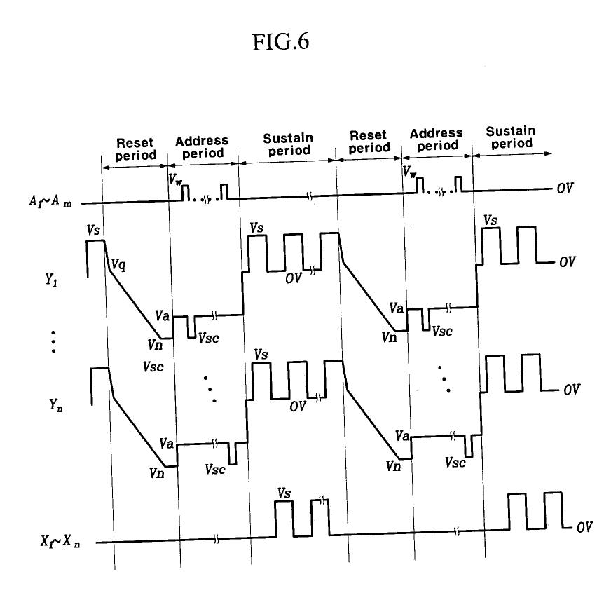

Referring now to FIG. 4, a PDP driving method according to a first exemplary embodiment of the present invention will be described. Notations of reference numerals as address electrodes A₁ to Aₘ, scan electrodes Y₁ to Yₙ, and sustain electrodes X₁ to Xₘ represent that the same voltage is applied to the address electrodes, the scan electrodes, and the sustain electrodes, and notations of reference numerals as address electrodes Aᵢ and scan electrodes Yⱼ represent that a corresponding voltage is applied to some of the address electrodes and the scan electrodes.

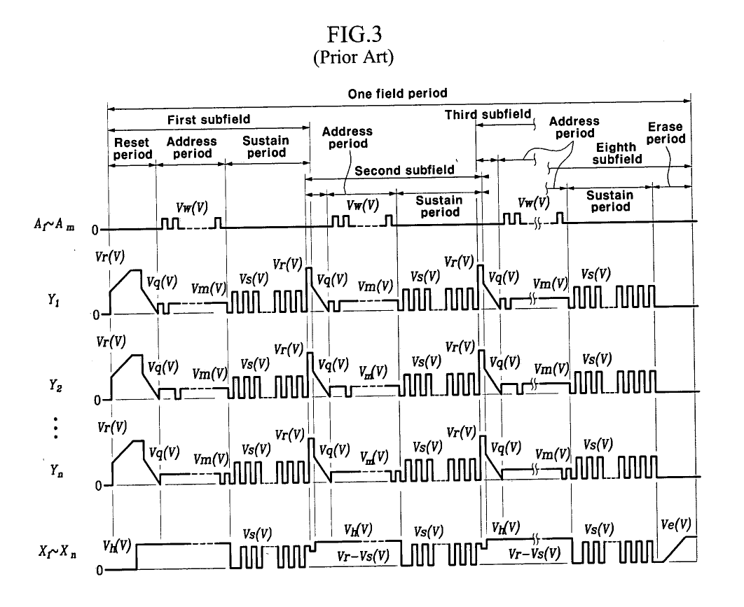

FIG. 4 shows a PDP driving waveform diagram according to a first exemplary embodiment of the present invention. As shown, the driving waveform includes a reset period, an address period, and a sustain period. The PDP is coupled to scan/sustain driving circuit 20 as seen in FIG. 2 for applying a driving voltage to scan electrodes Y₁ to Yₙ and sustain electrodes X₁ to Xₙ and to address driving circuit 30 as seen in FIG. 2 for applying a driving voltage to address electrodes A₁ to Aₘ in each period. The driving circuits and the PDP coupled thereto configure a plasma display.

The wall charges formed in the sustain period are eliminated in the reset period, discharge cells to be displayed are selected from among the discharge cells in the address period, and the discharge cells selected in the address period are discharged in the sustain period.

In the sustain period, sustain discharging is performed by a difference between the wall voltage caused by the wall charges formed in the discharge cells selected in the address period and the voltage formed by the sustain pulse applied to the scan electrode and the sustain electrode. Voltage Vₛ is applied to scan electrodes Y₁ to Yₙ at the last sustain pulse in the sustain period, and a reference voltage (assumed as 0V in FIG. 4) is applied to sustain electrodes X₁ to Xₙ. The selected discharge cell is discharged between scan electrode Yⱼ and sustain electrode Xⱼ, and negative and positive wall charges are respectively formed on scan electrode Yⱼ and sustain electrode Xⱼ.

In the reset period, a ramp voltage which gradually falls from voltage V_{q} to voltage Vₙ is applied to scan electrodes Y₁ to Yₙ after the last sustain pulse is applied in the sustain period, and reference voltage 0V is applied to address electrodes A₁ to Aₘ, and sustain electrodes X₁ to Xₙ are biased with voltage Vₑ. When the discharge firing voltage between the address electrode and the scan electrode in the discharge cell is set to be voltage V_{fay}, last voltage Vₙ of the falling ramp voltage corresponds to voltage −V_{fay}.

In general, when the voltage between the scan electrode and the address electrode or between the scan electrode and the sustain electrode is greater than the discharge firing voltage, a discharge occurs between the scan electrode and the address electrode or between the scan electrode and the sustain electrode. In particular, when the gradually falling ramp voltage is applied to generate discharges as described in the first exemplary embodiment, the wall voltage in the discharge cell is reduced by the same gradient as that the of falling ramp voltage. Sine this principle is disclosed in detail in U.S. Pat. No. 5,745,086, no corresponding descriptions will be provided.

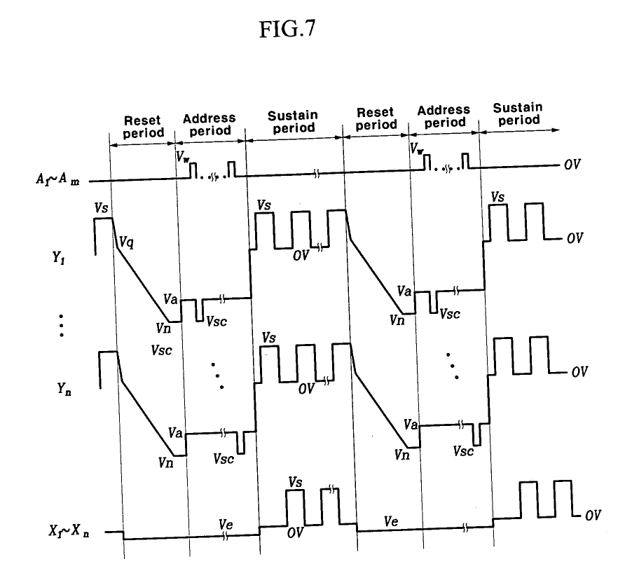

Referring to FIG. 5, a discharge characteristic when the ramp voltage falling to voltage −V_{fay} is applied will be described. FIG. 5 shows a relational diagram between a falling ramp voltage and a wall voltage when the falling ramp voltage is applied to the discharge cells. Scan electrodes and address electrodes will be described in FIG. 5 assuming that a predetermined wall voltage Vₒ is formed since negative and positive charges are respectively accumulated on the scan and address electrodes before the falling ramp voltage is applied. As shown, when the difference between wall voltage V_{wall} and voltage V_{y} applied to the scan electrode becomes greater than discharge firing voltage V_{fay} while the voltage applied to the scan electrode is gradually reduced, a discharge is generated, and wall voltage V_{wa11} in the discharge cell is reduced by the same gradient as that of failing ramp voltage V_{y}. In this instance, the difference between falling ramp voltage V_{y} and wall voltage V_{wall} maintains discharge firing voltage V_{fay}. Accordingly, wall voltage V_{wall} between the address electrode and the scan electrode within the discharge cell reaches 0V when voltage V_{y} applied to the scan electrode is reduced to voltage −V_{fay}.

Since the discharge firing voltage is varied according to characteristics of the discharge cells, voltage V_{y} applied to the scan electrode is to allow all the discharge cells to be discharged from address electrodes A₁ to Aₘ to scan electrodes Y₁ to Yₙ. All the discharge cells include discharge cells which are provided at an area that can influence displaying a screen on the PDP.

That is, as given in Equation 1, difference V_{A-Y,reset} between voltage 0V applied to address electrodes A₁ to Aₘ and voltage Vₙ applied to scan electrodes Y₁ to Yₙ is established to be greater than maximum discharge firing voltage V_{f,MAX} of the discharge cell which has the greatest discharge firing voltage from among the discharge cells which have the discharge firing voltages of V_{fay}. In this instance, it is desirable for the size |Vₙ| of voltage Vₙ to correspond to maximum discharge firing voltage V_{f,MAX} since a negative wall voltage is formed when size |Vₙ| of voltage Vₙ is far greater than maximum discharge firing voltage V_{f,MAX}.
V_{A-Y,reset}=|Vₙ|≧V_{f,MAX} Equation 1

As described, the wall voltage is eliminated from all the discharge cells when a ramp voltage which falls to voltage Vₙ is applied to scan electrodes Y₁ to Yₙ. A negative wall voltage can be generated in the discharge cells having discharge firing voltage V_{f} of less than maximum discharge firing voltage V_{f,MAX} when the size |Vₙ| of voltage Vₙ is set to be maximum discharge firing voltage V_{f,MAX}. That is, the negative wall charges are generated on address electrodes A₁ to Aₘ and scan electrodes Y₁ to Yₙ. The generated wall voltage in this instance is a voltage for solving non-uniformity between the discharge cells in the address period.

In the address period, the voltages at scan electrodes Y₁ to Yₙ and sustain electrodes X₁ to Xₙ are maintained at reference voltage 0V and voltage Ve respectively, and voltages are applied to scan electrodes Y₁ to Yₙ and address electrodes A₁ to Aₘ so as to select discharge cells to be displayed. That is, negative voltage V_{sc} is applied to scan electrode Y₁ of the first row, and positive voltage V_{w} is applied to address electrode A₁ which is concurrently provided on the discharge cell to be displayed in the first row. Voltage V_{sc} corresponds to voltage of Vₙ in FIG. 4.

Accordingly, as given in Equation 2, voltage difference V_{A-Y,address} between address electrode Aᵢ and scan electrode Y₁ in the discharge cell selected in the address period always becomes greater than maximum discharge firing voltage V_{f,MAX}.
V_{A-Y,address}=V_{A-Y,reset}+V_{w}≧V_{f,MAX} Equation 2

Therefore, addressing is generated between address electrode Aᵢ and scan electrode Y₁ and between sustain electrode X₁ and scan electrode Y₁ in the discharge cell formed by address electrode Aᵢ to which voltage of V_{w} is applied and scan electrode Y₁ to which voltage of V_{sc} is applied. As a result, positive wall charges are formed on scan electrode Y₁ and negative wall charges are formed on sustain electrode X₁ and address electrode Aᵢ.

Next, voltage V_{sc} is applied to scan electrode Y₂ in the second row, and voltage V_{w} is applied to address electrode Aᵢ provided on the discharge cell to be displayed in the second row. As a result, addressing is generated in the discharge cell formed by address electrode Aᵢ to which voltage V_{w} is applied and scan electrode Y₁ to which voltage V_{sc} is applied, and hence, the wall charges are formed in the discharge cell. In a like manner, voltage V_{sc} is sequentially applied to scan electrodes Y₃ to Yₙ in the residual rows, and voltage V_{w} is applied to the address electrodes provided on the discharge cells to be displayed, thereby forming the wall charges.

In the sustain period, voltage Vₛ is applied to scan electrodes Y₁ to Yₙ and reference voltage 0V is applied to sustain electrodes X₁ to Xₙ. The voltage between scan electrode Yⱼ and sustain electrode Xⱼ exceeds discharge firing voltage V_{fxy} between the scan electrode and the sustain electrode in the discharge cell selected in the address period since the wall voltage caused by the positive wall charges of scan electrode Yⱼ and the negative wall charges of sustain electrode Xⱼ formed in the address period is added to voltage Vₛ. Therefore, sustain discharging is generated between scan electrode Yⱼ and sustain electrode Xⱼ. Negative and positive wall charges are respectively formed on scan electrode Yⱼ and sustain electrode Xⱼ of the discharge cell on which the sustain discharging is generated.

Next, 0V is applied to scan electrodes Y₁ to Yₙ and voltage Vₛ is applied to sustain electrodes X₁ to Xₙ. In the previous discharge cell in which the sustain discharging is generated, the voltage between sustain electrode Xⱼ and scan electrode Yⱼ exceeds discharge firing voltage V_{fxy} between the scan electrode and the sustain electrode since the wall voltage caused by the positive wall charges of sustain electrode Xⱼ and the negative wall charges of scan electrode Yⱼ formed in the previous sustain discharging is added to voltage Vₛ. Therefore, the sustain discharging is generated between scan electrode Yⱼ and sustain electrode Xⱼ, and the positive and negative wall charges are respectively formed on scan electrode Yⱼ and sustain electrode Xⱼ of the discharge cell in which the sustain discharging is generated.

In the like manner, voltage Vs and 0V are alternately applied to scan electrodes Y₁ to Yₙ and sustain electrodes X₁ to Xₙ to maintain the sustain discharging. As described, the last sustain discharging is generated while voltage Vs is applied to scan electrodes Y₁ to Yₙ and 0V is applied to sustain electrodes X₁ to Xₙ. A subfield which starts from the above-noted reset period is provided after the last sustain discharging.

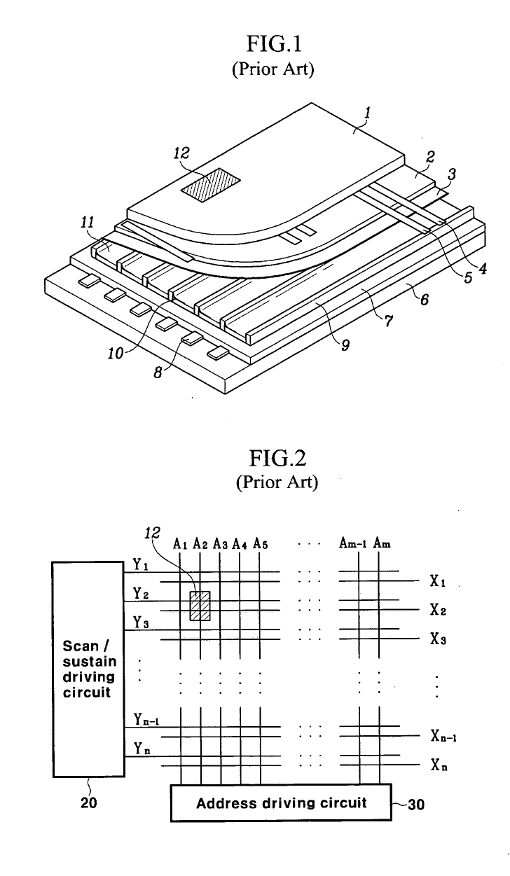

In the first exemplary embodiment, the addressing is generated when no wall charges are formed in the reset period, by allowing the voltage difference between the address electrode and the scan electrode of the discharge cell to be displayed in the address period to be greater than the maximum discharge firing voltage. Hence, the problem of worsening the margins is removed since the addressing is not influenced by the wall charges formed in the reset period. The amount of discharging is reduced in the reset period compared to the prior art since no wall charges are used in the addressing, and there is no need to form the wall charges by using the rising ramp voltage in the reset period in the same manner of the prior art. Therefore, the contrast ratio is improved since the amount of discharges by the reset period is reduced in the discharge cells which do not emit light. Further, the maximum voltage applied to the PDP is lowered since voltage Vᵣ is eliminated of FIG. 1.

The circuit for driving the scan electrodes is simplified since voltages V_{sc}, Vₙ can be supplied by the same power by making voltages of V_{sc}, Vₙ correspond to each other. In addition, the addressing is generated irrespective of the wall charges since the voltage difference between the address electrode and the scan electrode in the selected discharge cell can be greater than the maximum discharge firing voltage by greater than voltage V_{w}.

In the first exemplary embodiment, the reference voltage is established to be 0V, and it can further be set to be other voltages. When it is possible to allow the difference between voltages V_{w}, V_{sc} to be greater than the maximum discharge firing voltage, voltage V_{sc} can be different from voltage Vₙ.

Next, relationships of discharge firing voltage V_{fay} between the address electrode and the scan electrode, discharge firing voltage V_{fxy} between the sustain electrode and the scan electrode, and voltage Vₛ in the first exemplary embodiment will be described. The discharge of the PDP is determined by the amount of secondary electrons generated when the positive ions are collided with the cathode, referred to as a γ process. Accordingly, the discharge firing voltage of when the electrode covered with matter of a high secondary electron emission coefficient γ is operated as the cathode is less than the discharge firing voltage of when the electrode covered with matter of a low secondary electron emission coefficient γ. In a 3-electrode PDP, the address electrode formed on the rear substrate is covered with a phosphor for representation of colors, and the scan electrode and the sustain electrode formed on the front substrate is covered with a film which has a high secondary electron emission coefficient such as MgO. Since the scan electrode and the sustain electrode are symmetrically formed and the address electrode and the scan electrode are asymmetrically formed, the discharge firing voltage between the address electrode and the scan electrode is varied depending on the case in which the address electrode is operated as an anode and the case in which the address electrode is operated as a cathode.

That is, discharge firing voltage V_{fay} of when the address electrode covered with a phosphor is operated as an anode and the scan electrode covered with a dielectric layer is operated as a cathode is less than discharge firing voltage V_{fya} of when the address electrode is operated as a cathode and the scan electrode is operated as an anode. The relation of discharge firing voltage V_{fay} of when the address electrode is an anode, discharge firing voltage V_{fya} of when the address electrode is a cathode, and discharge firing voltage V_{fxy} of between the scan electrode and the sustain electrode satisfies Equation 3. The relation is variable according to states of the discharge cells.
V_{fay}+V_{fya}=2V_{fxy} Equation 3

Since the scan electrode is operated as a cathode in the reset period and the address period, discharge firing voltage V_{fay} of between the address electrode and the scan electrode is given as Equation 4 from Equation 3. Since no sustain discharge is to be generated in the discharge cells which are not addressed in the address period, voltage Vₛ is less than discharge firing voltage V_{fxy} of between the scan electrode and the sustain electrode as expressed in Equation 5.
V_{fay} [symbol] V_{fxy} Equation 4
Vₛ [symbol] V_{fxy} Equation 5

Since the wall voltage between the address electrode and the scan electrode is established to be near 0V during the reset period in the first embodiment, no consecutive discharge is to be generated between the scan electrode and the address electrode and between the sustain electrode and the address electrode during the sustain period in the discharge cells which are not addressed during the address period. In detail, the case of consecutive generation of discharge includes a case in which a discharge is generated between the scan electrode and the address electrode by applying voltage Vₛ to the scan electrode to generate, and a discharge is generated between the sustain electrode and the address electrode when voltage Vₛ is applied to the sustain electrode after the positive wall charges are formed on the address electrode because of the discharge generated between the scan electrode and the address electrode. Since sustain electrode and the scan electrode are symmetric, the discharge firing voltage between the sustain electrode and the address electrode corresponds to voltage V_{fay}, and the wall voltage formed on the sustain electrode and the address electrode when the positive wall charges are accumulated on the sustain electrode by the discharge of the scan electrode and the address electrode is not established to exceed voltage V_{fay}. Therefore, voltage V_{fay} is to be greater than voltage V_{g}/2 as given in Equation 6 so that no discharge may occur when voltage Vₛ is applied after the positive wall charges are formed on the sustain electrode according to the discharge between the scan electrode and the address electrode.
Vₛ−V_{fay} [symbol] V_{fay}V_{fay} [symbol] Vₛ/2 Equation 6

From Equations 4 to 6, voltage V_{fay} is determined near voltage Vₛ since voltage V_{fay} is established to be greater than voltage Vₛ/2 and voltages V_{fay}, Vs are to be less than voltage V_{fxy} by greater than a predetermined voltage.

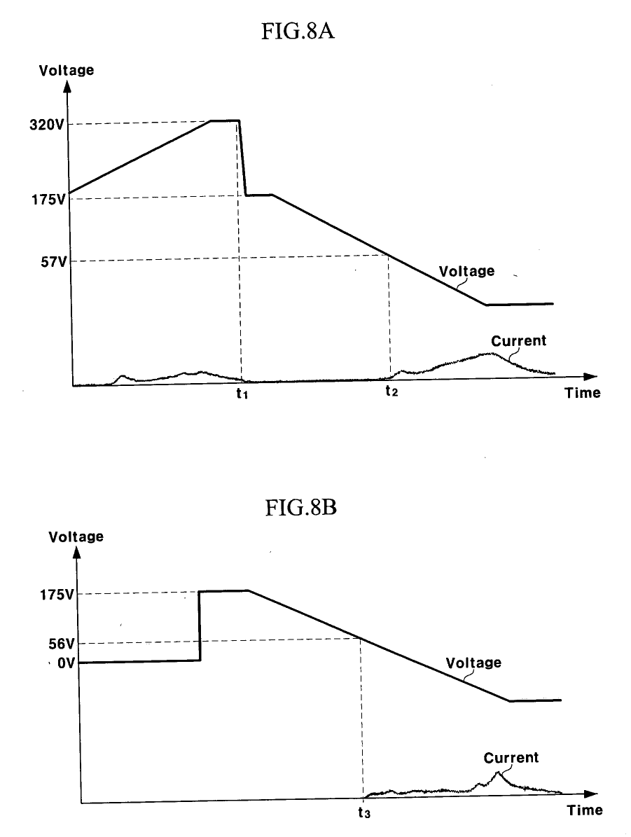

FIG. 8A shows a voltage applied diagram for measuring the discharge firing voltage, and FIG. 8B shows discharged states in the sustain period and the reset period. The voltages at the sustain electrode and the address electrode are not illustrated, the discharge current at the time when the falling ramp voltage is applied to the scan electrode is only illustrated in FIG. 8B. When 0V is applied to the sustain electrode and the scan electrode at the finished time of the sustain period, a self erase discharge can be generated between the address electrode and the scan electrode because of the wall voltage formed between the address electrode and the scan electrode. Hence, wall voltage V_{way} formed between the address electrode and the scan electrode in the sustain period is needed to be established less than the discharge firing voltage V_{fay} between the address electrode and the scan electrode as given in Equation 7. In this instance, since the positive wall charges are formed on the address electrode and the negative wall charges are formed on the scan electrode, the discharge firing voltage is discharge firing voltage V_{fay} when the address electrode is an anode.
V_{way}<V_{fay} Equation 7

In general, the wall charges which are able to maintain the voltage which is half the voltage between the scan electrode and the sustain electrode are formed on the address electrode in the sustain period. Therefore, wall voltage V_{way} between the scan electrode and the address electrode when voltage Vₛ is applied to the scan electrode and 0V is applied to the sustain electrode and the address electrode is given in Equation 8.
V_{way}=(V_{wxy}+Vₛ)/2 Equation 8

The voltage between the scan electrode and the sustain electrode (a summation of an externally applied voltage and the wall voltage) is maintained at the discharge firing voltage state when the voltage at the scan electrode is gently varied as described above. As shown in FIG. 8A, when the voltage at the scan electrode is gradually increased while the voltage (not shown) at the sustain electrode is fixed to be 0V, a weak discharge is generated between the scan electrode and the sustain electrode, and wall charges are formed between the scan electrode and the sustain electrode. As the voltage at the scan electrode is increased, wall charges are formed so that the voltage between the scan electrode and the sustain electrode may be maintained at the discharge firing voltage. When the voltage at the scan electrode is increased to reach the final voltage of 320V and the wall voltage is formed between the scan electrode and the sustain electrode, the voltage (not shown) at the sustain electrode is fixed to be 165V, and the voltage at the scan electrode is gradually decreased. In this instance, the time at which a weak discharge is generated again between the scan electrode and the sustain electrode is a time at which the varied voltage between the scan electrode and the sustain electrode is double the discharge firing voltage. Accordingly, since the discharge is generated when the voltage at the scan electrode is 57 V referring to FIG. 8A, it is assumed that double the discharge firing voltage is 428V which is the summation of 320V and (165−57)V. That is, discharge firing voltage V_{fxy} between the scan electrode and the sustain electrode is approximately 214V.

Referring to FIG. 8B, voltage Vₛ (=175V) is applied to the scan electrode in the final part of the sustain period to generate a final sustain discharge, wall voltage V_{wxy} is formed between the sustain electrode and the sustain electrode, and the voltage at the scan electrode is gradually decreased while the voltage (not shown) at the sustain electrode is fixed to be 165V. In this instance, it is known that a weak discharge is generated between the scan electrode and the sustain electrode when the voltage at the scan electrode approximately reaches 56V, which is the case in which the summation of the voltages applied to the scan electrode and the sustain electrode and the wall voltage formed between the scan electrode and the sustain electrode becomes discharge firing voltage V_{fxy}. Therefore, it is known from Equation 9 that wall voltage V_{wxy} formed between the scan electrode and the sustain electrode in the sustain period is approximately 105V, that is, about 60% of voltage Vₛ.
V_{fxy}(214V)=(165−56)V+V_{wxy} Equation 9

Since wall voltage V_{xxy} formed in the sustain period is 60% of voltage Vs, wall voltage V_{way} formed between the scan electrode and the address electrode in the sustain period corresponds to 80% of voltage Vₛ from Equation 8. Therefore, it is known from Equation 7 that discharge firing voltage V_{fay} between the scan electrode and the address electrode is greater than 0.8Vₛ.

In FIG. 4, voltage Vₑ applied to sustain electrodes X₁ to Xₙ in the reset period and the address period is set to be a positive voltage. Voltage Vₑ can be varied if a discharge can be generated between scan electrode Yⱼ and sustain electrode Xⱼ by the discharge between scan electrode Yⱼ and address electrode Aᵢ in the address period. For example, voltage Vₑ can be 0V or a negative voltage as shown in FIGS. 6 and 7.

The voltage applied to the address electrode during the reset period has been described to be 0V in the above-described embodiments, and since the wall voltage between the address electrode and the scan electrode is determined by the difference of the voltages applied to the address electrode and the scan electrode, the voltages applied to the address electrode and the scan electrode can be differently established when the difference of the voltages applied to the address electrode and the scan electrode satisfies the relations which correspond to the exemplary embodiments.

The ramp type voltages have been described to be applied to the scan electrode during the reset period in the embodiments, and in addition, other types of voltage for generating a weak discharge and controlling the wall chares can be applied to the scan electrode. Levels of the other types of voltages are gradually varied according to time variation.

As described, the problem of worsening the margins by loss of wall charges is removed since the addressing is not influenced by the wall charges formed in the reset period. The contrast ratio is enhanced since the amount of discharges in the reset period is reduced in the discharge cells which do not emit light. The maximum voltage applied to the PDP is reduced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A method for driving a plasma display panel having a plurality of first electrodes and second electrodes formed in parallel on a first substrate, and a plurality of address electrodes which cross the first electrodes and second electrodes and are formed on a second substrate, wherein adjacent first electrodes, second electrodes, and address electrodes form a discharge cell, the method comprising:
gradually reducing a voltage generated by subtracting a voltage at the address electrode from a voltage at the first electrode to a second voltage from a first voltage, during a reset period;
respectively applying a third voltage and a fourth voltage to the first electrode and the address electrode of the discharge cell to be selected from among the discharge cells, during an address period; and
sustain discharging the discharge cell selected in the address period, during a sustain period,
wherein the second voltage is substantially less than a negative value of half of a difference of the applied voltages between the first electrodes and the second electrodes for the sustain discharging in the sustain period.

2. The method of claim 1, wherein the second voltage is substantially less than a negative value of 80% of a difference of the applied voltages between the first electrodes and the second electrodes for the sustain discharging in the sustain period.

3. The method of claim 1, wherein the second voltage is substantially less than a negative value of a discharge firing voltage between the first electrode and the address electrode.

4. The method of claim 3, wherein the discharge firing voltage fires a discharge when substantially no wall charges are formed in the discharge cell.

5. The method of claim 3, wherein a wall voltage between the first electrode and the address electrode is substantially eliminated during the reset period.

6. The method of claim 3, wherein the discharge firing voltage is the greatest one from among the discharge firing voltages of the discharge cell in a valid display region.

7. The method of claim 3, wherein a difference of the third voltage and the fourth voltage is greater than the discharge firing voltage.

8. The method of claim 1, further comprising reducing the voltage of the first electrode to a fifth voltage from the final voltage applied to the first electrode during the sustain period of a previous subfield, wherein the fifth voltage allows the voltage difference between the first electrode and the address electrode to be the first voltage.

9. The method of claim 1, wherein the voltage difference between the first electrode and the address electrode is reduced to the second voltage from the first voltage during the reset period of all the subfields forming at least one field.

10. A plasma display comprising:
a first substrate;
a plurality of first electrodes and second electrodes formed in parallel on the first substrate;
a second substrate facing the first substrate with a gap therebetween;
a plurality of third electrodes crossing the first electrodes and the second electrodes and being formed on the second substrate; and
a driving circuit for supplying a driving voltage to the first, second, and third electrodes so as to discharge the discharge cells formed by adjacent first, electrodes, second electrodes, and third electrodes,
wherein the driving circuit gradually reduces the voltage generated by subtracting a voltage at the third electrode from a voltage at the first electrode to a first voltage during a reset period, discharges a discharge cell to be selected from among the discharge cells during an address period, and sustain-discharges the selected discharge cell during a sustain period, and
wherein the first voltage is substantially less than a negative value of a voltage which corresponds to half of the voltage applied to the first electrodes and the second electrodes for the sustain discharging in the sustain period.

11. The plasma display of claim 10, wherein the first voltage is substantially less than a negative value of a voltage which corresponds to 80% of the difference of the applied voltages between the first electrodes and the second electrodes for the sustain discharging in the sustain period.

12. The plasma display of claim 10, wherein the first voltage is substantially less than a negative value of a discharge firing voltage between the first electrode and the third electrode.

13. A method for driving a plasma display panel having a plurality of first electrodes and second electrodes formed in parallel on a first substrate, and a plurality of third electrodes which cross the first electrodes and the second electrodes and are formed on a second substrate, wherein adjacent first electrodes, second electrodes, and third electrodes form a discharge cell, wherein a field is divided into a plurality of subfields and then driven, each subfield includes a reset period, an address period, and a sustain period, and all subfields respectively form at least one field, the method comprising:
gradually reducing a voltage at the first electrode from a first voltage to a second voltage, during the reset period;
respectively applying a third voltage and a fourth voltage to the first electrode and the third electrode of the discharge cell to be selected from among the discharge cells, during the address period; and
sustain discharging the discharge cell selected in the address period, during the sustain period, wherein the voltage at the first electrode falls to the first voltage after the last pulse of the sustain period of the previous subfield.

14. The method of claim 13, wherein no additional wall charges are formed in the discharge cell during the reset period.

15. The method of claim 13, wherein, during the reset period, a fifth voltage generated by subtracting a voltage applied to the third electrode from the second voltage is less than a negative value of a voltage which corresponds to half of a sixth voltage which corresponds to the difference of the voltages applied to the first and second electrodes for the sustain discharging during the sustain period.

16. The method of claim 14, wherein the fifth voltage is less than a negative value of 80% of the sixth voltage.

17. The method of claim 13, wherein the voltage applied to the third electrode is 0V during the reset period.

18. A method for driving a plasma display panel having a plurality of first and second electrodes formed in parallel on a first substrate, and a plurality of address electrodes which cross the first and second electrodes and are formed on a second substrate, wherein the adjacent first electrode, the second electrode, and the address electrode form a discharge cell, the method comprising:
sequentially applying a first voltage to the first electrodes, and applying a second voltage to the address electrode while the first voltage is applied to the first electrode of the discharge cell to be selected from among the discharge cells,
wherein the first voltage is substantially less than a negative value of half of a voltage which corresponds to a third voltage which corresponds to the difference of voltages applied to the first electrodes and the second electrodes for the sustain discharging during the sustain period.

19. The method of claim 18, wherein the first voltage is less than a negative value of 80% of the third voltage.

20. The method of claim 18, further comprising gradually reducing a voltage generated by subtracting a voltage at the third electrode from a voltage at the first electrode to the third voltage during the reset period.
